(19) United States
(12) Patent Application Publication
(10) Pub. No.: US 2010/0235916 A1
(43) Pub. Date: Sep. 16, 2010

(54) Apparatus and method for computer virus detection and remediation and self-repair of damaged files and/or objects

(76) Inventor: Peter V. Radatti, Conshohocken, PA (US)

Correspondence Address: Frank J. Bonini, Jr.;Harding, Earley, Follmer & Frailey, P.C., P.O. Box 750, Valley Forge, PA, 19482-0750, US

(21) Appl. No.: 12/658,768

(22) Filed: Feb. 5, 2010

Related U.S. Application Data
(63) Continuation-in-part of application No. 10/404,378, filed on Apr. 1, 2003.
Application No. 10/404,378 is a continuation-in-part of application No. 10/032,251, filed on Dec. 21, 2001, now Pat. No. 7,661,134.

(51) Int. Cl. G06F 12/14; G06F 11/07

(52) U.S. Cl. 726/24; 714/746; 714/811; 714/E11.024; 714/E11.023

(57) ABSTRACT

A method and apparatus for detecting and remediating damaged files as well as files containing proscribed code content, involving locating damage or proscribed code within a file, recording an identity of said file in which damage or proscribed code has been located, removing the damage or proscribed code by destroying the file that contains the damage or proscribed code, utilizing a search utility to locate a copy of the destroyed file according to one or more locations which are designated, and when located, copying the file to the original location of the destroyed file.

### CROSS-REFERENCE TO RELATED APPLICATIONS

This application is a continuation-in-part of, and claims priority to, U.S. patent application Ser. No. 10/404,378 filed on Apr. 1, 2003, and U.S. patent application Ser. No. 10/032,251 filed on Dec. 21, 2001, issued on Feb. 9, 2010 as U.S. Pat. No. 7,661,134 the disclosures of which are incorporated herein by reference.

### BACKGROUND OF THE INVENTION

1. Field of the Invention

The present invention relates to computer virus detection and restoration of infected files.

2. Brief Description of the Related Art

Malicious code may infect computers and networks and render files or entire computers and networks inoperable. Often, malicious code may be present in the form of viruses, worms and trojan horses. A trojan horse generally is defined as a program which performs a useful function, but also performs an unexpected action as well. A virus is generally considered to be a code segment which replicates by attaching copies to existing executables. Another type of malicious code is referred to as a worm, which is a program which replicates itself and causes execution of the new copy. A network worm is a worm which copies itself to another system by using common network facilities, and causes execution of the copy on that system. A computer program which has been infected by a virus has been converted into a virtual host. For example, a program is expected to perform a particular useful function, however, when a program file is infected with viral code, the execution of that file has the unintended side effect of viral code execution. In addition to performing the unintended task, the virus also performs the function of replication. Upon execution, the virus attempts to replicate and attach itself to another program. It is the unexpected and generally uncontrollable replication that makes viruses so dangerous. Viruses are currently designed to attack single platforms, a platform being considered to be defined as the combination of hardware and the most prevalent operating system for that hardware. As an example, a virus can be referred to as an IBM-PC virus, referring to the hardware, or a DOS virus, referring to the operating system. “Clones” of systems are also included with the original platform.

Another example is a Trojan horse. A Trojan horse generally may be obtained by a file that a user seeks or attempts to download, but unsuspectingly, the download contains malicious code which the user did not desire. Any number of actions may be performed by the Trojan horse. Foe example, when run, instead of doing what the user intends or expects, or in addition to doing what the user anticipates, it undertakes undesired function, such as, for example, unloading and installation of hidden programs, commands, scripts, or execution of any number of commands. These function are done by the Trojan horse without the user's knowledge or consent.

Malicious code may damage files and render computers, networks, and computer hardware inoperative or ineffective or subvert their functions. Files and file components may be damaged by viruses, especially where the virus replaces or attaches malicious code. Virus detection and removal programs may remove the virus, or merely direct a pointer to another location and avert the virus from becoming activated. However, the live virus code may still be resident on the system.

Often viruses may take the form of replacement of the content of a file with the virulent code. For example, a file may be replaced with a Trojan file for subversion. Therefore, a filename may remain the same, but when the program executes the code, based on the file name, the virus code is instead executed. In many cases, a file determined to contain a virus is quarantined. This may include placing the file in new or separately designated directory so that file is no longer accessible if called for. The file may be renamed to avoid activation when the original file name is subsequently called for by a program operation. When files are determined to contain a virus and are quarantined, or removed, the programs which rely on those files no longer have the files available for use. Files which have been disinfected by antivirus programs or software cannot be trusted and may not fulfill their functions correctly. Disinfection therefore is generally imperfect. Damages to any file from any cause may create malfunctions and are undesirable. A system therefore may have successfully rendered the virus ineffective, but at the same time, compromised the operation of one or more programs. When the system calls for an operation required to execute the program that requires the deleted file that is no longer available, the program may not function. Often, unless a log showing changes that have taken place to files is examined, it is often difficult to ascertain what needs to be done with the program. In some cases, the file may be part of a group of files, and reinstallation of the entire program may be required. In particular, where the file has evolved, and contains code developed from updates, which the file may have undergone, there may not be a replacement file readily available in the form in which it is needed.

A need exists for a virus disinfecting method and apparatus which may be operated to remove malicious code through destruction of the file in which the code is found and to facilitate continuity of system operations through locating and restoring files.

### SUMMARY OF THE INVENTION

The invention relates to a method and apparatus for remediating damaged files, including by disinfecting proscribed code from files damaged by proscribed code, as well as by remediating files damaged by other means, including, for example, from unauthorized changes to a file. The method and apparatus may be used in conjunction with a computer, a computer network, hardware and network components. The method and apparatus may in addition, or alternately, be useful in conjunction with computing components which contain or utilize programs, and which communicate with one or more other sources, such as for example, including other networks, removable media, or other managed or associated components.

A controller engine is provided and may include software programmed with instructions for performing an evaluation of the computer or network environment, such as, for example, the operating system, programs registered, and network connections, as well as hardware that may be used by the computer or accessible on a network. The software of the controller engine also may be programmed with instructions to record and store data on a storage component, as well as make available reports using a reporting engine to report the evaluation results to a recipient, which, for example, may be another program, engine or user. The controller engine software may include instructions to select one or more disinfection utility programs to run. For example, a disinfection utility module may include a software program configured with instructions so that a processor may be operated to carry out one or more disinfection steps. A plurality of programs may be employed or made available for use in order to facilitate the detection and elimination of proscribed code. The controller engine may include instructions for managing detection programs, as well as instructions for the replacement and/or repair of files determined to be infected. According to one embodiment, a full replace utility, such as a full replacement engine (FRE), facilitates replacement of an infected, suspect or damaged file with a known good copy. According to one embodiment, a disinfection step may be to carry out an operation which destroys a file or file component. A file component may be a file or a group of files. According to another embodiment, a disinfection step may remove the infected file or file component in its entirety. The controller engine may include, or be used in conjunction with the full replacement utility. The full replacement utility may include a replacement module having software programmed with an instruction that directs a processor to undertake steps to search for a copy of a file or file component that was destroyed, such as for example, as a result of a positive detection result. For example, a positive detection result may include where unauthorized changes to a file have been made, or where a virus or other proscribed code is present. The replacement module may be instructed to search in particular locations or sources for the replacement file. According to some embodiments, the location may be a predetermined, preferred location. According to other embodiments, the location may be an open sourced location, or in other words, a location that is not specifically designated by the program. The replacement module may include a source selection engine which may include software programmed with instructions for directing the processor to run a search routine to locate a replacement file from a particular source, or from one or more designated or preferred sources.

According to some embodiments, a disinfection server is provided. The disinfection server may contain a database of files stored for use in the event a file is needed by the FRE. Authentication of a license, key, or other subscription indicator may be used to verify that a request to obtain a file from the disinfection server is from a valid requestor.

### DETAILED DESCRIPTION OF THE PREFERRED EMBODIMENTS

A method and apparatus for disinfecting proscribed code from a computer, computer network, network component or other device. According to embodiments of the invention, a disinfection controller component (DCC) may be provided. A file replacement utility (FRU) which may include a file replacement engine (FRE) may be provided to operate in conjunction with the DCC. The FRE may facilitate remediation of an infected file. The DCC may include software programmed with instructions for carrying out a detection routine, one embodiment, the DCC includes an instruction for one or more engines to operate such as, for example, an evaluation engine, scanning engine, and an analysis engine to carry out one or more detection routines. The DCC may be stored on a storage device, such as, for example, a hard drive of a computer, a disk or other media. The storage device may be operatively connected with, or accessible to, a processor. According to one embodiment, the DCC may be stored on a storage component which is linked with a processor. The DCC may be configured with instructions for evaluating the environment of a subject computer, computer network, or other component which contains or may be managed by software. The DCC may include an evaluation engine which is programmed to collect environmental data from the subject computer, network or device, and may evaluate the environmental data, which may involve the detection of results by detecting the operating system, and one or more programs installed or registered on a computer, or other component on a network or system. The DCC evaluation engine may store and/or process the detection results obtained. The DCC analysis engine, may use the detection results and be programmed with instructions for comparing the results of the detection with one or more stored data profiles to determine the types of scanning and proscribed code analyses that are to be carried out.

The scanning designated by the DCC may include one or more scanning tools of the VFIND® Security Tool Kit (VSTK) (CYBERSOFT®).A scanning engine may be provided to scan for the presence of malicious code in the files of a subject computer, network component or device. The DCC may be configured to perform a selection of one or more scanning utility programs, such as the virus scanning programs of the VSTK.

One example of a detection program which the DCC may instruct to run is a macro virus disinfection program. For example, where the DCC analysis engine determines that there is a match for macros, the DCC scanning engine may be instructed to perform a macro virus detection routine. The scanning engine may include one or more malicious code detection routines or programs. A commercially available macro virus disinfection program, such as MvFilter (CYBERSOFT®), may be used. The MvFilter program may be used to facilitate disinfection of OLE documents (Microsoft® Word®, Excel® and PowerPoint®) from macro viruses (both VBA and Word Basic, as well as others). MvFilter may be programmed with an instruction to remove the macro. MvFilter may be used for compartmentalization purposes in addition to its reactive disinfection role. As a compartmentalization tool, MvFilter may be used to proactively prevent macro virus infections, including new unknown infections, by automatically stripping all macros from OLE documents as they enter a system. The DCC analysis engine may record the results of the MvFilter operation. In the event proscribed code is determined to be contained in a macro, the DCC analysis engine may report those results to the full replacement engine (FRE). The FRE may be configured to remediate the suspected malicious code. The FRE may be provided with one first option that includes an instruction to have the FRE destroy the file by deleting the file in its entirety, or another option which permits the macro to be destroyed, instructing the processor to leave other portions of the file, such as, for example, the file header.

The DCC analysis engine or the program it instructs to run (such as a scanning program or another program or engine operating in connection therewith), records the location of the file that is determined to contain proscribed code (and the device identification on which the suspect file exists). When the file determined to contain proscribed code (suspect file) is deleted, the name and location of the file is recorded, and the recorded location stored in a file location database.

As discussed herein, the DCC analysis engine may be configured to select one or more virus detection programs to run. For example, the DCC scanning engine may instruct a processor to run CIT® (CYBERSOFT®), a program that determines and detects baseline changes. According to one example, a macro virus detection scan may be performed, the scanning engine may be configured to perform additional scanning detection protocols, such as, for example, file tampering evaluations. Examples of methods and apparatus which may be used for the detection of malicious code include those contained in my U.S. patent application Ser. No. 10/032,251, filed on Dec. 21, 2001, which may be used for detecting virus, hacker, sabotage and baseline configuration violations from any source using cryptographic change detection. Where the scanning, such as with the CIT®, indicates that a deviation or violation exists, an alert may be communicated to the FRE. The alert may contain the file which the CIT® determined should have been present. Information may also be communicated to the FRE to determine the file that is required. The FRE may be operated so that it destroys a file (or files) which do not match the CIT® determination baseline.

The DCC may be configured to determine that replacement of a file is inappropriate, and therefore, may be configured to run a disinfection routine, such as, for example, a macrofile disinfection system.

A file identification engine (FIE) may be provided for determining the identity of the file which has been determined (through CIT®, or another detection operation) to contain proscribed code. As referred to herein, proscribed code may include malicious code, such as, for example, viruses, trojan horses, worms, as well as other code determined to be in violation of a desired state or system configuration. For example, an identification of a file which is to be destroyed may be recorded, as described herein, such as, for example, in a file location database. Determination of the file to be destroyed (the destroyed file identity) may be accomplished based on one or more characteristics of the file, such as, for example, the file name, an applied hash code, such as the MD5 algorithm, or other mechanisms including heuristics.

The DCC scanning engine may include one or more additional malicious code detection programs. For example, where the scanning engine carries out a macro virus disinfection routine, such as, for example, with MvFilter, a macro may be stripped from a file. The full replacement engine (FRE) may include a file location engine (FLE). According to one embodiment, macros which are needed may be obtained through a file location engine (FLE). In the event that a detection and removal operation is carried out, such as, for example, with the MvFilter, and a user needs a macro, according to one embodiment, the full replacement engine (FRE) may be instructed to implement a locating engine, such as the FLE, for locating one or more replacement macros from one or more specified locations. The full replacement engine (FRE) may include software with instructions for operating a processor to undertake a search for a copy of the destroyed file (that is, a file matching the file destroyed). The FRE may be programmed with the feature of a locating instruction which provides one or more designated locations within which to search for the presence of the file.

According to some embodiments, the FRE may be configured so that a user may apply selection criteria to determine the specific location or locations which are to be searched for the presence of a copy of the destroyed file (e.g., the file that was identified to contain a damage condition or proscribed code). The selection criteria may be specifically designated, by designating a server, directory, or specific combination of them, or through a menu option with one or more pre-defined location options. Alternately, the locating instruction may instruct the search to proceed in more locations than the designated locations and any located files based on the locations from which they may be obtained. For example, where a file is located in a non-designated location, (where an option permits searching in locations other than only those designated) that result may be returned as a location result. The location result may be communicated to a reporting engine for reporting, or made available as data for further processing with a processor.

Where the processor is instructed by the file location engine (FLE) to carry out a location procedure for locating a file, and a copy of a destroyed file being sought is located, the FRE may generate a location alert and communicate the file location information to a file download engine. The file download engine may be part of the FRE and may include software programmed with an instruction to download the located copy of the damaged file to a buffer location, or may download the file directly to the location previously occupied by the file that was damaged. According to one embodiment, the downloaded engine may report the downloaded-file, file-information to the controller engine, and the controller engine may determine whether the file information meets selected criteria. If it does, the scanning engine may be operated to scan the downloaded file with the selected scanning utility or with one or more programs designated by the controller engine. According to some embodiments, the downloaded file may be deleted, if determined to contain malicious code, and the controller engine (or other designated component) of the system instructed may report the information to the location engine. The location engine may proceed to locate another copy of the original file that was damaged, but excluding the file and/or location from which the previously downloaded file (which the scanning engine rejected) was obtained. The procedure may be repeated until a copy of the file is located and is acceptable (i.e., not rejected by the scanning engine). The downloaded file, prior to being installed, may be analyzed for proscribed code in order to make sure that the file is an acceptable replacement for the damaged file. Proscribed code detection apparatus and methods, including, for example the methods and apparatus disclosed in my U.S. patent application Ser. No. 09/838,979, now U.S. Pat. No. 7,502,939, may be used in conjunction with the download engine to evaluate located files which are to be downloaded. Alternately, files may be downloaded to a buffer where the downloaded files may be analyzed, including by a component of the file download engine (FDE), to determine whether the file contains malicious code. The FDE may select one or more scanning operations to carry out for a downloaded file. According to some embodiments, the FDE may report to the controller component (DCC) or to a scanning engine.

According to one or more embodiments, a backup of files may be provided or generated. For example, a stored local backup of the target file to be located may exist on a local backup location, which for example, may include a computer storage component, including the computer on which the original damaged file was located.

One example of a commercially available method and apparatus which may be used to provide a backup of files is a product sold under the brand AVATAR® distributed by CYBERSOFT®. AVATAR® may be used to facilitate maintenance of a baseline configuration of a computer file system. It does so by executing system security policies that act as an intrusion detection and response system. According to the AVATAR® method and apparatus, if the system baseline configuration is modified, for any reason, it may be configured to be detected by AVATAR® and returned to the correct baseline configuration. In accordance with one embodiment of the present method and apparatus, the download engine may be configured so that one selection of a selection menu, or an option for locating copies of the target damaged file, is a baseline configuration file directory. The file download engine (FDE) may be selectively configured to obtain files for replacement based on the baseline configuration and from a designated location. When this option is selected, or indicated for operation, the files located correspond with the baseline configuration. The files may be hashed to obtain a hash value, and the downloaded files to be replaced may be hashed and their hash checked against a stored hash value. AVATAR® may be utilized to operate in conjunction with the download engine.

According to one or more embodiments, the FRU also may include a file replacement engine (FRE). The file replacement engine (FRE) may include software programmed to replace one or more downloaded or copied replacement files. The FRE may instruct a processor to replace the target replacement file immediately upon download (or upon identification of a suitable target file replacement, if a copy is already present on or at the same file location). The replacement instruction may include the location of the damaged file, and an instruction to move or copy the target replacement file to that location.

According to one embodiment, a baseline file configuration may be determined, and the configuration is set to maintain that baseline. The FRE may include a maintenance_manager which has a retrieval manager, as described in my U.S. patent application Ser. No. 10/404,378, which may broadcast, over a network connection or connections, a retrieval signal indicating it needs the file or files that the maintenance_manager has presumed is insecure, damaged and/or missing. One potential inquiry may be whether a detected change is an approved change. A list or indication of approved changes may be provided and may be updated so that the system though detecting a change, may not require the maintenance_manager, or other system component, to undertake to replace or retrieve the approved changed file. The retrieval signal may be broadcast over a connection reserved for it, in some embodiments, and in other embodiments, the signal may be broadcast over a general use channel, e.g., the Internet. According to some embodiments, the retrieval manager does not direct the retrieval signal to any particular machine, aside from those that are running a receive signal module of the embodiment. According to other embodiments, the retrieval manager is configured to direct a retrieval signal to a particular machine According to other embodiments, the retrieval signal is a general request directed to any machine which is capable of responding, such as, for example, a public network.

For example, the retrieval signal may be received by one or more servers, which may be systems, file servers, network attached storage devices, storage applications, etc. According to some embodiments, the server may be of a different operating system type than the client machine. As described in my U.S. patent application Ser. No. 10/404,378, the server does not have to be preidentified as trusted, and, in fact, may be entirely invisible to the client, as the client may be to the server. Indeed, in certain embodiments, a hash code and initial requesting or retrieved signal may be the only transferred information. Embodiments may use an unknown or untrusted source to furnish a trusted result. However, if desired, certain servers may be identified, or become identified as preferred, and so those servers would be desirable. Once a server or servers receives the retrieved signal from the client, the systems respond by first, determining from their own database of hashed files if they have the file, and next, responding with the appropriate file. The server side database of hashed files may be predetermined, generated when desired, etc. If a copy of the requested file is returned to the client from a server, the client hashes the file, and checks the hash against its stored hash database. If more than one copy is returned, the client may be configured to accept the first received and refuse the remainder. Alternatively, the FRU may be configured to determine rules or preferences as to which file to accept. If the hash comparison is true, the FRE will reinstall the file on the client. In other embodiments, a hash database may be supplied to or be present on the client that contains hashes of files to be installed and/or updated. Thus, the FRE may be configured so that any files obtained from a source would have their hash checked against that database in order to be installed and/or updated. If the hash comparison does not prove true, then an alerting engine may be triggered to provide an alert (which may be a message, email, or other notification function), or, alternately, or in conjunction therewith, to send an appropriate instruction, such as destroy the copied file which has been located, or move that file to a secure location so that a further treatment options may be made.

Another option is that upon locating a file whose hash is not confirmed as a match with that of the damaged file for which a replacement is being sought, the locating cycle is repeated, and the FLE resumes a search for an additional replacement file copy. The FRE may be configured to instruct a processor to search in one or more designated locations, which may be considered secondary locations where a file is not located (or where a file located does not match the damaged file) or may search in one or more locations or on one or more servers. The secondary locations may be locations other than the locations from which the file was obtained, but whose hash did not match. The FRE may be provided with a location utility which may be configured to avoid locations or servers which return files which do not match, such as, for example when their hash codes are checked and do not return a match. The FRE may include a source selection engine (SSE). The source selection (SSE) engine facilitates management of the file location, and the full replace engine (FRE) may utilize the located file copy and, through a download module of or associated with the FRE, download the file for replacement of the damaged filed. According to open sourced location embodiments, the source selection engine may include or be linked with a search engine programmed to conduct a search of file servers and web sites on the Internet, including public peer to peer networks, in an effort to locate the target file copy of the damaged file that was destroyed. According other embodiments, a central location is maintained to serve as a location where files may be stored for subsequent searching. For example, where a file has changed over time as a result of conditions or operations, a backup or copy of the most current version of a file may be designated to be stored at a designated location.

According to some embodiments, the FRU may include a census_manager which takes an inventory of files stored on and/or used by a client or subscriber to the disinfection system. A file repository is maintained and includes copies of files (e.g., such as system files, all file, or designated files) available for retrieval in the event a file of a client becomes infected.

According to some embodiments, the file repository may contain copies of program files. Considering one example, if client B is a subscriber, the census_manager may be configured to take an inventory of client B's machine (computer, server, network components or other files containing components). The file inventory is compared with the files in the file repository. If, for example, client B has the program WORD®, and the version is currently matching with those of the file repository, the census_manager records client B's file inventory information but does not download the file. If for example, client C is determined to have a file Program.exe and Program.exe is not contained in the file repository, then the file Program.exe is copied, and added to the file repository. The census_manager may be linked to a file identification engine (FIE). The FIE may be instructed to authenticate the downloaded file Program.exe. A file integrity utility (FIU) may be employed to attempt to compare the downloaded file via hash value comparison, version, or other method, with a known trusted copy, such as, for example, a version obtained from the file vendor. According to some embodiments, the downloaded program.exe is not made part of the accessible file repository until the downloaded file is authenticated. According to other embodiments, the file is only available to client C, the client from which the file was originally obtained for storage in the repository.

The FRU may collect, store, report and analyze data obtained for the file destruction, locating and replacement operations. A database of inaccurate servers and/or locations, as well as a database of accurate servers/locations may be kept and used to refine further requests. The FRU may be configured to learn from the return rates for trusted or correct files (e.g., matches being sought, file types being sought), and may generate a selection preference based on return rates. The return rates may be considered for particular file types, file size, or one or more other attributes.

According to one embodiment, where a specified file location is a secure location where backup copies of the files are stored, and the download engine is unable to obtain files from that location, the FRU may be configured to locate files on a public peer to peer network. This may be done by file type, file program, or other designation. That is, the location where a file may be designated for location may bear a relationship to one or more attributes of that file.

As described in connection with my U.S. patent application Ser. No. 10/404,378, in some embodiments, the same system may act as both client and server. Thus, the system may refer to an internal file server, such as when a file name has been inappropriately changed, a file has been corrupted in a crash, etc. In a loopback type embodiment, for example, regular file integrity checks may be made of files in a system that are likely to be corrupted during system operation. If corrupted, the request would be then of the internal system server without the need to access a network. The FRU may be configured with an instruction to operate a location utility, such as the FLE, to search for files when they are not available from the client server system. According to some embodiments, the FRU may be configured to locate a copy of a damaged file from any location. For example, public peer to peer networks may be searched to locate a file match for the replacement of the damaged. According to some embodiments, the location of a file match for the replacement of a damaged file may be carried out even where that file was destroyed as part of a remediation process, including a process to disinfect or otherwise render the file harmless.

According to one embodiment, a database of files is maintained for access by the FRU. According to other embodiments, the FRU may seek a replacement file from a disk containing the file. For example, the disk may be read only, ensuring that the contents may not be changed. According to other embodiments, the FRU may provide a notification alert, so that a user may determine whether to attempt to replace the file from a disk, or whether to use an alternate source. Other embodiments provide an Internet-based disinfection server. The Internet-based disinfection server contains data for identification of the clients, so that it may be used by authorized clients. According to some embodiments, the client authorization may be a check to determine whether a client is registered client of the disinfection server or system, and in other embodiments, the client authorization may comprise a check to determine whether the client is a licensed user of a subscriber to the disinfection system. For example, if client A is a licensee of program W, and the licensor or supplier of program W is a subscriber to the disinfection system, according to some embodiments, the disinfection system may identify client A as being authorized.

The FRU may operate a location utility and return a file which is a legitimate good copy of the damaged file (the file determined to be infected). The location utility may include or be linked with an authentication engine. The authentication engine may be configured to contain identification data, such as, for example, an activation key or other indicia which may be stored in conjunction with the FRU so that files requested from a subscriber disinfection server may authenticate the FRU request, and permit a file download. The FRU may be configured to locate files only from the subscriber server, or one or more associated subscriber servers made available through or by the subscription. Alternately, the FRU may be configured to locate files for replacement from public networks. A file integrity utility may be provided to check the integrity of a file which is to be obtained, or which has been obtained from a public source.

An integrity component also may be provided to authenticate that the download request for a replacement file is being made from an authorized user, that is a user who is licensed for that file. This may be done through an exchange of data from the requesting computer. For example, one integrity process may be through a comparison of an activation key to determine whether the key is a match for a valid user or license. The activation key also may be compared to determine whether that key is associated with an active maintenance contract, or in other words, is a current licensee or has a valid license.

The central file location may, for example, include a storage component linked with a server. The storage component stores files, and may serve as a repository for authorized licensees or users seeking a file replacement copy. For example, according to one embodiment, a disinfection vendor (D) of the DCC and FRU components may license the method for use by licensed users. The disinfection vendor (D) may have, or have access to, one or more copies of replacement files and may regulate access to the replacement file copies through the licensing arrangement with the system users, for example, clients or licensees.

The user authentication may be accomplished using an encryption mechanism, and return of information, such as files matching the request, and also may be accomplished with encryption to provide transit protection so that the file is delivered to the requesting location, or a location specified by the request, without damage to the file. Suitable decryption components may be utilized to decrypt the delivered file. For example, the FRU may have a decryption engine which may be utilized to decrypt.

According to one embodiment, a notification mechanism is provided to facilitate notification to a user or component when a file is damaged or destroyed and a replacement file cannot be found. For example, the notification may provide notification, or may provide an option to perform a locating operation in one or more alternate or optional locations which were not designated, or not searched previously. For example, where a source was not included as a location, such as, for example, where a specific file location is designated, and other sources are not, an option may be presented to attempt to locate the file in other sources. Another embodiment attempts to locate the file in one or more sources which have not been designated, and does not download the file, but records the location of the file, and provides the location to a user or component as a further option to select the file or location. If a selection is made for an optional location, the location engine attempts to retrieve that file.

Alternately, a designated location may return a notification that the file was not located because the location designated could not be accessed. An option may be to try another time, or may be to attempt to locate the file in another location. The locating engine may be programmed with an instruction to attempt a number or time span to apply to download requests for locating a copy of the damaged file.

According to an alternate embodiment, the FRU may be configured to remove an unauthorized change or virus, as well as a damaged file, and replace the damaged file with what the file should be. The FRU may accomplish this in conjunction with a macro file disinfection routine, which the FRU may be configured to implement.

While the invention has been described with reference to specific embodiments, the description is illustrative and is not to be construed as limiting the scope of the invention. For example, the methods and apparatus disclosed in U.S. patent application Ser. No. 10/404,378, filed on Apr. 1, 2003; U.S. patent application Ser. No. 10/032,251, filed on Dec. 21, 2001, now U.S. Pat. No. 7,661,134; U.S. patent application Ser. No. 10/032,252 filed on Dec. 21, 2001, now U.S. Pat. No. 7,143,113, and U.S. patent application Ser. No. 10/060,631 filed on Jan. 30, 2002, now U.S. Pat. No. 7,363,506, may be utilized in conjunction with the inventions disclosed herein, and these disclosures are herein incorporated by reference. In addition, various modifications and changes may occur to those skilled in the art without departing from the spirit and scope of the invention described herein and as defined by the appended claims.

What is claimed is:

1. A method for detecting and remediating proscribed code, comprising:
locating proscribed code within a file;
recording an identity of said file in which said proscribed code has been located;
removing the proscribed code;
operating a full replacement utility to replace said file, said full replacement utility having software configured to locate a copy of said file that was damaged;
designating one or more locations wherein said copy of said file that was damaged may be located;
locating a copy of said file that was damaged,
and where a copy of said file that was damaged is located, reporting the location of said file;
copying said copy of said damaged file from said location;
replacing said destroyed file with said located copy of said damaged file.

2. The method of claim 1, wherein locating a copy of the damaged file involves evaluating the potential located copy for correspondence with the known good file that was damaged, and where the correspondence is positive, then copying the file and replacing the file.

2. The method of claim 1, wherein designating one or more locations comprises designating a particular source to serve as the location from which copies of files may be located.

3. The method of claim 1, wherein said one or more locations designated includes locations searchable on a network.

4. The method of claim 3, wherein the network is the internet.

5. The method of claim 3, wherein the network is a local network.

6. The method of claim 3, wherein the network is a network of a plurality of components, at least one of which comprises a storage component.

7. The method of claim 3, wherein said network is a public peer to peer network.

8. The method of claim 1, wherein recording an identity of said file in which said proscribed code has been located, includes recording the file type.

9. The method of claim 8, wherein designating one or more locations wherein said copy of said damaged file may be located comprises designating locations based on the file type of said damaged file.

10. The method of claim 1, wherein designating one or more locations wherein said copy of said damaged file may be located comprises designating a plurality of locations, wherein each of said plurality of locations includes a preference value relative to another one of said plurality of locations, and wherein locating a copy of said damaged file includes locating in order of preference from said plurality of designated locations.

11. The method of claim 1, wherein locating a copy of said damaged file comprises locating in designated locations and non-designated locations, and wherein when said file is located in a designated location, copying said copy of said damaged file from said designated location, and replacing said damaged file with said located copy of said damaged file obtained from said designated location, and, wherein when said file is located in a location other than a designated location, reporting the location of said file copy.

12. The method of claim 1, wherein copying said copy of said damaged file from said location comprises copying said copy of said damaged file to a secure area on a storage component.

13. The method of claim 11, including selecting in response to said reporting of said non-designated file location whether to replace said damaged file with the copy of said damaged file located in said non-designated location.

14. An apparatus for detecting and remediating proscribed code, comprising:
storage apparatus for storing files and at least one program for controlling a processor;
a processor operatively associated with the storage device, the storage device storing a program for controlling the processor; and
the processor operative with the program to conduct an analysis of one or more files to detect the presence of proscribed code;
wherein the processor is configured to perform the steps of:
identifying a file by file identification data;
analyzing a file to determine whether the file is designated to correspond with a file that contains proscribed code;
storing said file identification data;
and when said file is determined to contain proscribed code, recording the original location of said file and providing an instruction to (i) destroy said file by deleting said file from said file storage component which results in the deletion of said file or (ii) process the file to render the proscribed code non-harmful;;
locating a copy of said file with a locating engine having software configured to instruct the processor to search in one or more designated locations for a copy of said destroyed or processed file;
downloading a copy of said file from said one or more designated locations;
replacing in said destroyed or processed file original location said downloaded copy of said destroyed or processed file.

15. The method of claim 1, wherein said file includes a macro, and wherein said removal includes the removal from said file of said macro, and wherein locating a copy of the damaged file comprises locating a macro from one or more designated locations where the macro is contained, copying said copy of said damaged file from said location includes copying a copy of said macro; and wherein replacing said damaged file with said located copy of said damaged file comprises replacing the damaged file macro with the macro obtained from said one or more designated locations.

16. A method for remediating malicious code detection in a file, comprising:
identifying the location of the file in which the malicious code was detected;
destroying the malicious code by processing or deleting the file in which it is contained;
operating a full replacement utility to replace said file, said full replacement utility having software configured to locate a copy of said processed or destroyed file, wherein said full replacement utility includes an authentication engine for authenticating a user of the full replacement utility.

17. The method of claim 16, wherein, a file repository is provided, and wherein said file repository comprises a location wherein files are stored, and wherein said full replacement utility is configured to locate a copy of said processed or deleted file.

18. An apparatus for detecting proscribed code in one or more files and remediating the detected code through replacement of said file, comprising:
storage media on which software containing instructions for detecting proscribed code is be stored;
said storage media including software programmed with an instruction to process or destroy a file in which proscribed code is detected;
said storage media including software programmed with an instruction to search one or more locations for a copy of said processed or destroyed file, and, when a copy of said processed or destroyed file is located, copy said copy of said processed or destroyed file to the location where said file was located prior to the file being processed or destroyed.

19. The apparatus of claim 18, wherein said storage media comprises a chip.

20. The apparatus of claim 18, wherein said storage media comprises a memory component.

21. The apparatus of claim 18, wherein said storage media comprises a storage component of a computer, and wherein said apparatus further includes a processor.

22. A method for detecting and remediating damaged files, comprising:
locating a damage condition within a file;
recording an identity of said file in which said damage condition has been located;
removing the damage condition by destroying said file;
operating a full replacement utility to replace said file, said full replacement utility having software configured to locate a copy of said destroyed file;
designating one or more locations wherein said copy of said destroyed file may be located;
locating a copy of said destroyed file,
and where a copy of said destroyed file is located, reporting the location of said file;
copying said copy of said destroyed file from said location;
replacing said destroyed file with said located copy of said destroyed file.

23. The method of claim 22, wherein the damage condition comprises an unauthorized change to said file.

24. The method of claim 22, wherein said damage condition comprises a change to said file based on a known reference condition for said file.

25. An apparatus for detecting a damage condition in one or more files and remediating the detected damage condition through replacement of said file, comprising:
a computer configured with storage media on which software containing instructions for detecting a damage condition is stored and implemented;
said storage media including software programmed with an instruction to destroy a file in which a damage condition is detected;
said storage media including software programmed with an instruction to search one or more locations for a known good copy of said damaged file that was destroyed, and, when a known good copy of said file is located, copy said known good copy of said file to the location where said file was located prior to the file being destroyed.
